(19) United States
(12) Patent Application Publication
(10) Pub. No.: US 2008/0249893 A1
(43) Pub. Date: Oct. 9, 2008

(54) Apparatus and method for the ordering and creation of physical digital media

(75) Inventors: Aaron Knoll, Holtsville, NY (US); Jennifer Kelliher, Bellport, NY (US)

Correspondence Address: FELDMAN LAW GROUP PC, 12 E 41ST STREET, NEW YORK, NY, 10017, US

(73) Assignee: Protocall Technologies

(21) Appl. No.: 11/801,734

(22) Filed: May 10, 2007

Related U.S. Application Data
(60) Provisional application No. 60/799,008, filed on May 10, 2006.

(51) Int. Cl. G06Q 30/00

(52) U.S. Cl. 705/27

(57) ABSTRACT

The ability of retail stores to sell digital products through the secure distribution and delivery of digital video and/or audio content directly to a Portable Multimedia Device or a memory module that inserts into a portable media device.

### CROSS-REFERENCE TO RELATED APPLICATIONS

This application is based upon and hereby claims priority to U.S. Provisional Patent Ser. No. 60/799,008 filed May 10, 2006 and entitled APPARATUS AND METHOD FOR THE ORDERING AND CREATION OF PHSICAL DIGITAL MEDIA, hereby incorporated by reference.

### FIELD OF THE INVENTION

This invention relates generally to an apparatus and method of ordering and creating Physical Digital Media products. The products use a just-in-time, or one-off style of distributed manufacturing to facilitate broadcast companies in offering and distributing content viewed via Broadcast Television on Physical Digital Media. Physical Digital Media is defined as being either optical media, such as, Compact Disc and DVD; flash memory, such as, Compact Flash or Memory Stick; or any other machine-readable media.

### BACKGROUND

Advertising products on television has been a staple revenue source of the medium since 1941 when the Bulova Watch Company paid $9 to WNBT for a commercial aired during a baseball game between Brooklyn and Philadelphia. These commercials are used to generate revenue for the broadcaster so they can either create unique content or license content from a third party. However, as different forms of content distribution for Television/Video have evolved such as Internet downloads and direct-to-DVD releases, it is become more difficult for broadcasters to maintain their current levels of advertising revenue. There is now a need for a new and innovative way to generate a broadcaster's revenue utilizing the broadcaster's already existing, built-in channel that is broadcast in a consumer's home.

### SUMMARY OF THE INVENTION

To fulfill the need for a new and innovative way to generate a broadcaster's revenue utilizing the broadcaster's already-existing, built-in channel, the broadcaster can utilizes the already-existing channel to sell Physical Digital Media Products on-demand, via an interactive method direct to the Consumer. Therefore, the broadcasters and content providers can maximize their returns on broadcasts and increase their revenue far above that of traditional advertising.

By offering the sale of Physical Digital Media via the television is both attractive for the TV broadcasters as well as the content providers. The content providers will benefit from an additional revenue stream with little or no cost to them. The TV broadcasters are also able to create a new revue stream without creating inventory nightmares.

Accordingly, a principal object of the present invention is to create an apparatus and method to facilitate broadcasters and/or content providers in the complete process, from offer of sale to manufacturing, of a Physical Digital Media product.

Another object of the present invention is to create an apparatus and method for on-demand, or one-off style of manufacturing of Physical Digital Media.

Another object of the present invention is to create an additional revenue stream for content providers through directed advertising embedded on the Physical Digital Media product.

Another object of the present invention is to create an additional revenue stream for the TV Broadcasters.

Another object of the present invention is to utilize advanced cryptography to inhibit piracy.

Another object of the present invention is to eliminate up-front mass production and shipping costs.

Another object of the present invention is to decrease direct shipping costs by creating a distributed manufacturing structure.

It is intended that any other advantages and objects of the present invention that become apparent or obvious from the detailed description or illustrations contained herein are within the scope of the present invention.

### BRIEF DESCRIPTION OF FIGURES

FIG. 1 shows a four step schematic diagram relating to offering content to a consumer.

FIG. 2a illustrates a plurality of manufacturing units.

FIG. 2b shows examples of distributed manufacturing model configurations.

FIG. 2c shows a distributed model wherein multiple units are dispersed at multiple locations.

### DETAILED DESCRIPTION OF THE INVENTION

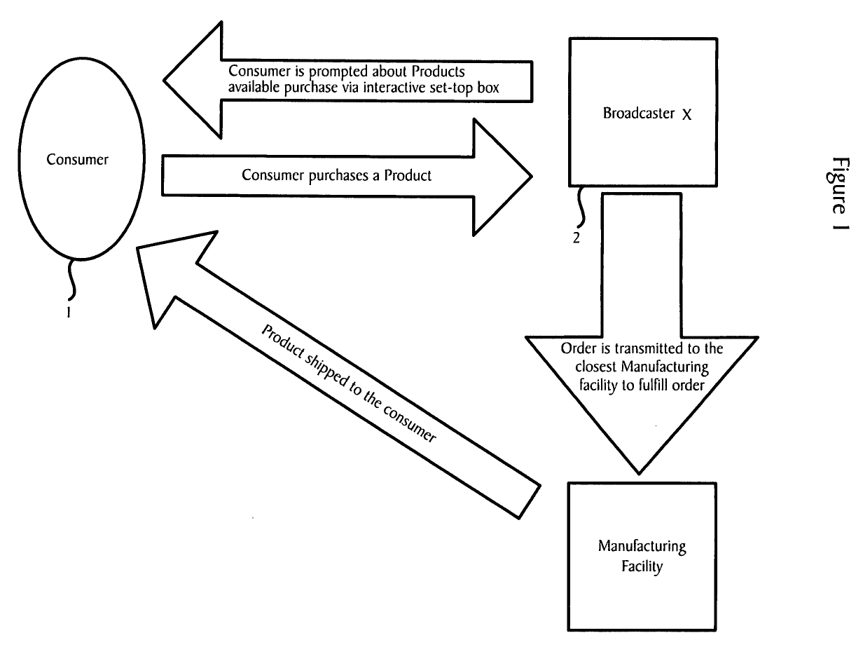

As shown in the FIG. 1, Broadcast Company 2, X, offers content to consumers 1. Content could be offered via Cable Television, Satellite Television, IP Television or other broadcast medium, to be viewed through a television 4 or other monitor 5. A variety of Physical Digital Media content could be offered such as DVD Video, Music CDs, or Video Games. The content offered to the consumer 1, could be related to what they recently viewed, or products associated with that content.

For example: The Consumer 1 watches the movie “Tomb Raider 1” on Satellite Television 5. At the end of the showing they are offered the following (Step 1).

a. Purchase the DVD.

b. Purchase the sequel.

c. Purchase the soundtrack.

d. Purchase the Play Station 2, Xbox, or PC Game.

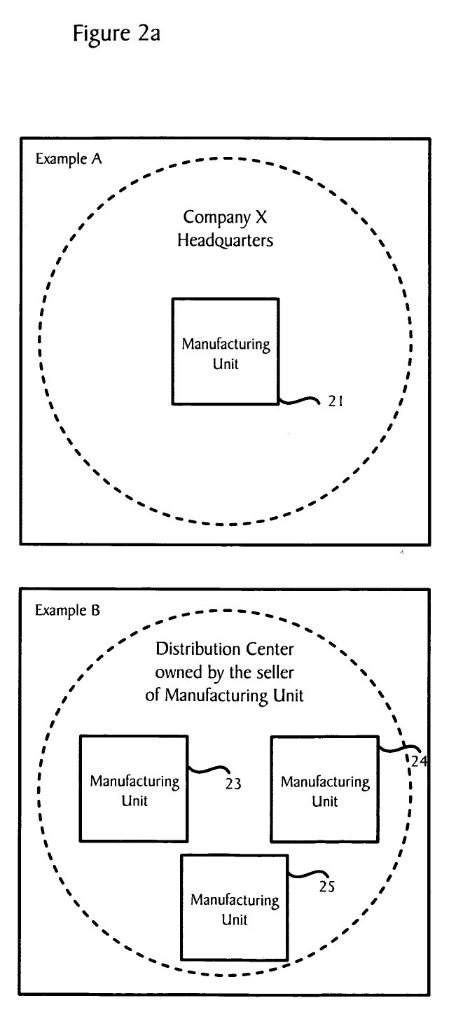

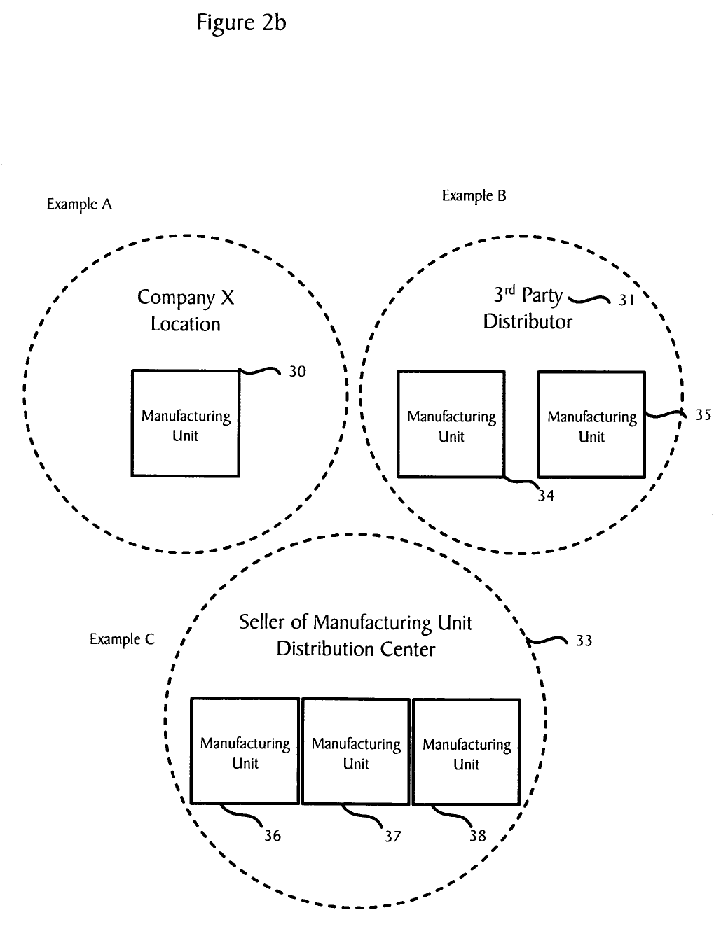

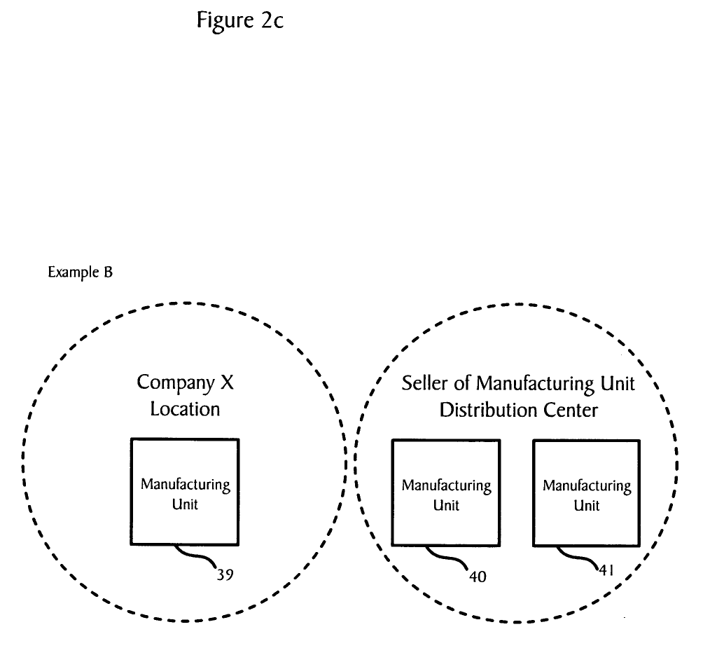

Once the order is placed through Company X's user interface 6 via the set-top box 7 (or other method) (Step 2) and is transmitted to a remote on-demand manufacturing unit 3 (Step 3). As shown by the examples in FIG. 2a one 21 or a plurality of manufacturing units 23, 24 and 25 can be located at one or many locations.

Manufacturing could be implemented using one or many manufacturing units centralized at a location 33 owned by the seller 30 of the manufacturing unit (example A of FIG. 2b), a Company X 30 owned location (example A of FIG. 2b), or at a location 34-35 owned by a 3rd party 31 (example B of FIG. 2b). Alternately, a distributed manufacturing model could be implemented in which, multiple units are dispersed at multiple locations 36-38 (Example C of FIG. 2b). These locations could all be owned by one of the parties named above, or some combination of the parties named above.

The on-demand, one-off, style of manufacturing allows for incorporation of additional features such as advanced anti-piracy methods to secure the data. Additional content such as bonus material or advertising may be inserted into Physical Digital Media. After the order is completed it would be shipped to the consumer and tracked for reporting and record keeping purposes (Step 4).

An alternate method of delivery for the product may be a download of the product to the set-top box, or any other recordable medium attached to the transmission device. It may be further understood that the set-top box or other medium may be capable of transferring the download to a portable memory device such as a DVD. The DVD may then be encrypted by the download source code so that the DVD will automatically erase after the DVD is viewed X number of times or Y number of days, as well as, having advanced anti-piracy methods to secure the data.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A method for selling Physical Digital Media products comprising the steps of:
(a) offering for sale contents to a consumer via a broadcast medium, whereby a broadcaster offers said contents, and said consumer views said contents through a monitor;
(b) purchasing said contents whereby said consumer places an order through said broadcaster using an interface;
(c) transmitting said order to a manufacturing unit;
(d) shipping said order to said consumer; and
(e) tracking said order.
